(19) United States
(12) Patent Application Publication
(10) Pub. No.: US 2024/0371149 A1
(43) Pub. Date: Nov. 7, 2024

(54) Method For Machine-Learning A Lidar Based Deep Learning Object Perception Apparatus And The Lidar-Based Deep Learning Object Detection Apparatus

(71) Applicants: Hyundai Motor Company, Seoul (KR); Kia Corporation, Seoul (KR); KOREA UNIVERSITY RESEARCH & BUSINESSS FOUNDATION, Seoul (KR)

(72) Inventors: Jong Won Park, Seoul (KR); Jin Kyu Kim, Seoul (KR); Da Eun Lee, Seoul (KR)

(21) Appl. No.: 18/521,360

(22) Filed: Nov. 28, 2023

(30) Foreign Application Priority Data
May 4, 2023 (KR) 10-2023-0058213

(51) Int. Cl. G06V 10/82; G06T 7/70; G06V 10/774

(52) U.S. Cl. CPC G06V 10/82; G06T 7/70; G06V 10/774; G06T 2207/10028

(57) ABSTRACT

The machine learning method for a LiDAR-based deep learning object perception apparatus comprises preparing an original dataset of a LiDAR point cloud; acquiring virtual object datasets from a point cloud database; adding the virtual object datasets to the original dataset based on an association of position information for each object to acquire a learning dataset; and training the LiDAR-based deep learning object perception apparatus using the learning dataset.

### CROSS-REFERENCE TO RELATED APPLICATION

The present application claims priority to Korean Patent Application No. 10-2023-0058213, filed on May 4, 2023, the entire contents of which is incorporated herein by reference in its entirety.

### RELATED FIELD

The present disclosure relates to a method for machine learning a LiDAR-based deep learning object perception apparatus and the LiDAR-based deep learning object perception apparatus.

### BACKGROUND

As the autonomous driving level advances, an improvement of the performance of the object perception apparatus is required.

To this end, an object perception method using a deep learning artificial intelligence model is being developed.

A LiDAR-based object detection apparatus using a conventional deep learning artificial intelligence model, i.e., a LiDAR-based deep learning object recognition apparatus, has a detection network that differentiates each type of object (i.e., by class). As a result of differentiating objects by class detection network in spite of achieving detection results of high reliability, there is a disadvantage in the increase of calculation overload from the large number of networks.

As an alternative, the thesis, “Class-balanced Grouping and Sampling for Point Cloud 3D Object Detection” (Benjin Zhu et al., 2019, arXiv: 1908.09492), proposes a multi-head architecture deep learning model.

The multi-head architecture deep learning model shares a backbone and includes different heads for each class to output perception results. This model, when there are many objects of a specific class among the objects included in the learning data, has an issue that deteriorates perception reliability for other class objects because the learning is concentrated on the corresponding class. In short, for example, when the number of vehicle data is large and the number of pedestrian data is considerably small in the training data, the detection performance for pedestrians deteriorate albeit yielding high perception performance for vehicles.

The imbalance in the number of objects by class included in the learning data becomes inevitable, and the above thesis does not propose a solution to the problem of gradient imbalance of the heads induced by imbalanced number of objects for each class.

The above thesis proposes a ground-truth sampling technique for data enhancement to resolve the imbalances for each class.

The ground-truth sampling technique is a method that increases the total number of corresponding class objects by collecting ground-truth point cloud datasets for an object of a required class from point cloud datasets, and then adding them as virtual objects to the learning data.

Although the imbalance for each class can be solved by adding virtual objects belonging to a specific class through this technique, there is an issue where objects are added in unrealistic positions since the method adds virtual data in arbitrary positions within the learning data.

Referring to FIG. 1A and FIG. 1B as an example, when the data is augmented by applying the convention ground-truth sampling technique to the original scene as shown in FIG. 1A, it causes an issue where pedestrians are added on a road as shown in FIG. 1B.

Due to these unrealistic data augmentation, performance improvements for object detection are limited.

### BRIEF SUMMARY

The purpose of the present disclosure is to solve at least one of the problems of the prior art described above, thereby improving the perception performance of the object perception apparatus.

One or more example embodiments of the present disclosure provides a method and apparatus for object detection based on a multi-head, deep-learning network, which can share an encoder (or backbone) and simultaneously perform perception on various classes of objects.

A method for machine learning a LiDAR-based deep learning object perception apparatus may include preparing original datasets of LiDAR point cloud, obtaining a virtual object dataset from a point cloud database, acquiring learning datasets by adding the virtual object dataset to the original datasets based on object-associated position information for each object, and training a LiDAR-based deep learning object perception apparatus using the learning datasets.

The virtual object dataset may include at least one dynamic object dataset from at least one point cloud dataset in the database.

In at least one embodiment of the present invention, the at least one dynamic object dataset includes at least one of a pedestrian, a bicycle, a motorcycle, a passenger car, a truck, a bus, a trailer, or a heavy construction equipment vehicle.

In at least one embodiment of the present invention, each position information by class is determined according to point label information of the original dataset.

In at least one embodiment of the present invention, the point label information includes at least one of a sidewalk, an area for traveling, or a road.

In at least one embodiment of the present invention, each object-associated position information includes associating the motorcycles, the passenger car, the truck, the bus, the trailer and the heavy construction equipment vehicle with the road, associating the pedestrian with the sidewalk, and associating the bicycle with the sidewalk and/or the road.

In at least one embodiment of the present invention, the deep learning object perception apparatus includes a non-transitory memory that stores object perception software based on a deep learning model and at least one processor executing the software of the memory, wherein the deep learning model includes a plurality of head networks that output losses for each class and a common (e.g., shared) backbone network.

In at least one embodiment of the present invention, the deep learning model outputs a final loss by calculating a weighted sum of the losses for each class.

In at least one embodiment of the present invention, the final loss is obtained through a Dynamic Weight Average (DWA) method.

In at least one embodiment of the present invention, the database includes nuScenes and/or KITTI datasets.

A LIDAR-based deep learning object perception apparatus, according to an embodiment of the present invention, comprises a non-transitory memory storing object perception software based on a deep learning model and at least one processor executing the software of the memory, wherein the deep learning model is trained by use of learning datasets obtained by adding a virtual object dataset to original datasets based on object-associated position information for each object, wherein the virtual object dataset is obtained from a point cloud database.

In the object perception apparatus of at least one embodiment of the present invention, the virtual object dataset includes at least one dynamic object dataset obtained from at least one point cloud dataset from the database.

In the object perception apparatus of at least one embodiment of the present invention, the dynamic object dataset includes at least one of a pedestrian, a bicycle, a motorcycle, a passenger car, a truck, a bus, a trailer, or a construction equipment vehicle.

In the object perception apparatus according to at least one embodiment of the present invention, the object-associated position information for each object is determined according to the point label information from the original datasets.

In the object perception apparatus of at least one embodiment of the present invention, the point label information includes at least a sidewalk, a drivable area, and a road.

In the object perception apparatus of at least one embodiment of the present invention, the object-associated position information for each object includes associating the motorcycles, the passenger car, the truck, the bus, the trailer and the construction equipment (e.g., construction vehicle) with the road, associating the pedestrian with the sidewalk, and associating the bicycle with the sidewalk and/or the road.

In the object perception apparatus according to at least one embodiment of the present invention, the deep learning object perception apparatus includes a non-transitory memory storing object recognition software based on a deep learning model and at least one processor executing the software of the memory, wherein the deep learning model includes a common (e.g., shared) backbone network and a plurality of head networks which each outputs a loss for each class.

In the object perception apparatus according to at least one embodiment of the present invention, the deep learning model outputs a final loss by calculating a weighted sum of the losses output from the plurality of head networks.

In the object perception apparatus according to at least one embodiment of the present invention, the final loss is obtained by Dynamic Weight Average (DWA).

In the object perception apparatus of at least one embodiment of the present invention, the database comprises nuScenes and/or KITTI datasets.

According to the embodiment of the present invention, the class imbalance of the object can be solved by augmenting data suitable for real situations, thereby improving perception performance.

### BRIEF DESCRIPTION OF DRAWINGS

FIG. 1A and FIG. 1B illustrate an example of data enhancement by a conventional ground-truth sampling technique.

FIG. 2 is a flowchart of a method of machine learning an object perception apparatus.

FIG. 3 illustrates a deep learning network architecture.

FIG. 4 illustrates a training process of a deep learning network.

FIG. 5 is a LiDAR-based deep learning object perception apparatus.

FIG. 6, FIG. 7A, and FIG. 7B are results of comparison between comparative samples.

### DETAILED DESCRIPTION

The present disclosure may be modified in various ways and have various embodiments, and specific embodiments will be illustrated and described in the drawings. However, this is not intended to limit the present disclosure to specific embodiments, and it should be understood that the present disclosure includes all modifications, equivalents, and replacements included on the idea and technical scope of the present disclosure.

The suffixes “module” and “unit” used herein are used only for name distinction between elements and should not be construed as being physically or chemically divided or separated or assuming that they can be divided or separated.

Terms including ordinals such as “first,” “second,” and the like may be used to describe various elements, but the elements are not limited by the terms. The terms are used only for the purpose of distinguishing one element from another element.

The term “and/or” is used to include any combination of a plurality of items to be included. For example, “A and/or B” includes all three cases such as “A”, “B”, and “A and B”.

When an element is “connected” or “connected” to another element, it should be understood that the element may be directly connected or connected to another element, but another element may exist in between.

The terminology used herein is for the purpose of describing particular embodiments only and is not intended to be limiting of the disclosure. Singular expressions include plural expressions, unless the context clearly indicates otherwise. In the present application, it should be understood that the term “include” or “have” indicates that a feature, a number, a step, an operation, a component, a part, or a combination thereof described in the specification is present, but does not exclude the possibility of existence or addition of one or more other features, numbers, steps, operations, components, parts, or combinations thereof in advance.

Unless otherwise defined, all terms used herein, including technical or scientific terms, have the same meaning as that generally understood by those skilled in the art. It will be understood that terms, such as those defined in commonly used dictionaries, should be interpreted as having a meaning that is consistent with their meaning in the context of the relevant art and will not be interpreted in an idealized or overly formal sense unless expressly so defined herein.

In addition, a unit or a control unit is a term widely used for naming a controller for controlling a vehicle specific function, and does not mean a generic function unit. For example, each unit or control unit includes a communication device communicating with another controller or sensor to control a function in charge, a memory storing an OS or logic command, input/output information, and the like, and one or more processors performing determination, calculation, determination, and the like necessary for controlling a function in charge.

First, the accompanying drawings will be briefly described.

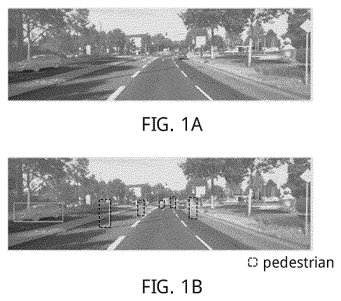

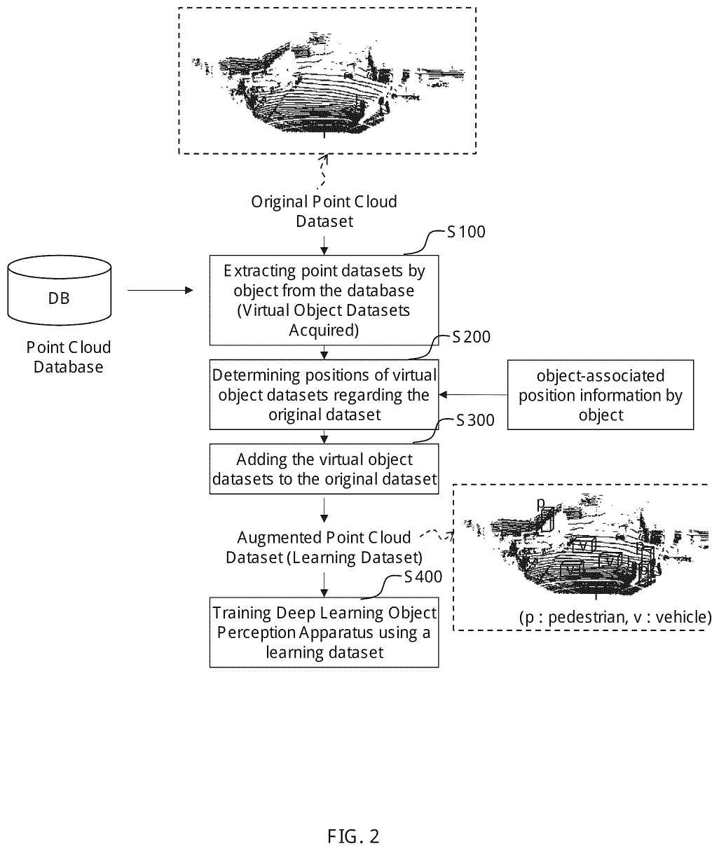

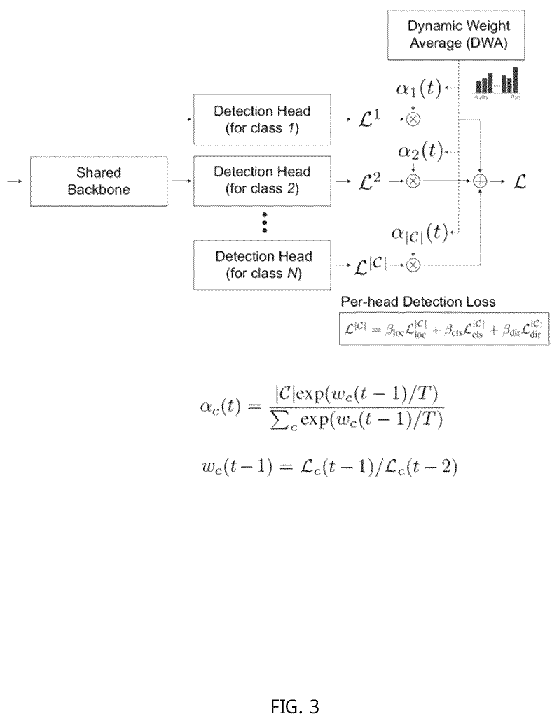

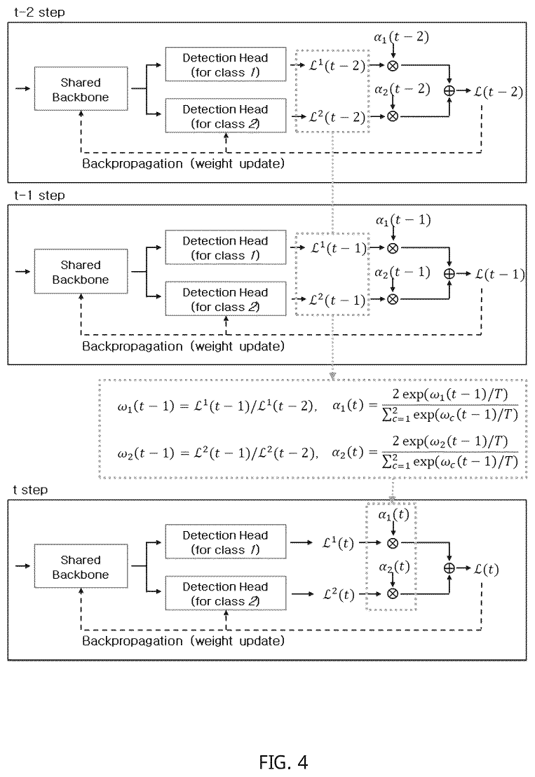

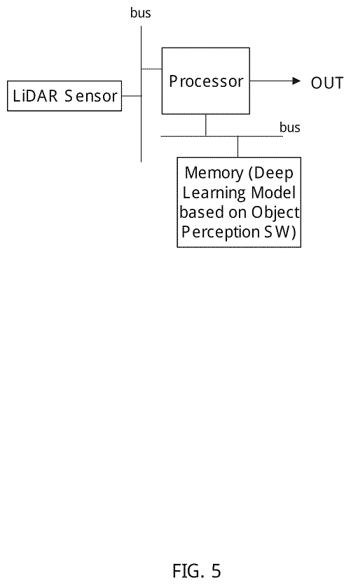

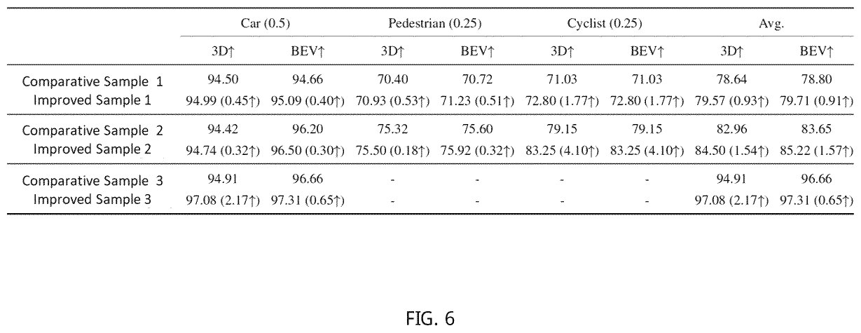

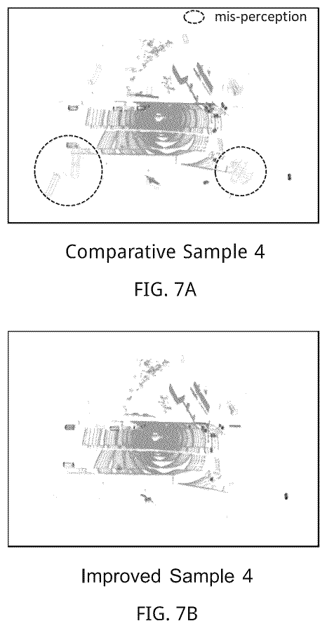

FIG. 1A and FIG. 1B illustrate an example of data enhancement by a conventional ground-truth sampling technique, and FIG. 2 illustrates a flowchart of a method of machine learning an object perception apparatus (also referred to as an object recognition apparatus). FIG. 3 illustrates a deep learning network architecture, and FIG. 4 illustrates a learning process of a deep learning network. FIG. 5 is a LiDAR semi-deep learning object perception apparatus. FIG. 6, FIG. 7A, and FIG. 7B are results of non-teaching the comparative sample (e.g., example).

An original point cloud dataset is provided in the machine learning method in reference to FIG. 2, and an original point cloud dataset is provided.

The original datasets are included in a database (DB) as described herein.

In addition, the original datasets are augmented through the later described steps of S100, S200, and S300, and thereby securing the augmented learning datasets.

In step S100, an object dataset for data enhancement is extracted. In order to extract the object dataset, at least one dataset is selected from the LiDAR point cloud database (DB), and the object dataset is extracted from the selected datasets. The extracted object datasets are added as virtual data to a scene of the original dataset and used as a virtual dataset for realizing data enhancement.

A database (DB) includes a ground truth cloud point dataset labeled (e.g., classified, categorized) for each point. For example, the database DB includes nuScenes and/or Karlsruhe Institute of Technology and Toyota Technological Institute (KITTI) datasets as open LiDAR datasets.

The virtual datasets are extracted according to point label (e.g., class, category) information of the ground truth datasets.

The extracted virtual dataset are dynamic objects.

Illustratively, the virtual dataset are dynamic objects that is at least a pedestrian, a bicycle, a motorcycle, a passenger vehicle, a truck, a bus, a trailer, or a construction equipment vehicle.

A contextual ground-truth sampling technique is proposed as a new data enhancing technique. The contextual ground-truth sampling technique is a method for adding virtual objects to learning data according to the corresponding context, and solves the issue of the added virtual objects to unrealistic positions from the conventional ground-truth sampling technique.

To this end, when the virtual datasets are added to the original datasets, the positions of the virtual dataset in the original datasets are determined based on the object-associated position information for each object (S200). The original dataset(s) may include, for example, point cloud data representing one or more objects and/or persons around (e.g., within a detection limit of a sensor) a LiDAR-equipped vehicle.

The object-associated position information for each object may be determined according to the point label information (e.g., class information, category information) of the original datasets.

For instance, the point label information includes labels (e.g., classes, categories) corresponding to at least one of a sidewalk, a drivable area, and/or a road.

Also, illustratively, the object-associated position information for each object includes an association of motorcycles, passenger vehicles, trucks, buses, trailers, and construction equipment (e.g., construction vehicles) to roads, an association of pedestrians to sidewalks, and an association of bicycles to sidewalks and/or roads.

Depending on the linked position information, the virtual dataset is added to the original datasets (S300).

In other words, motorcycles, passenger vehicles, trucks, buses, trailers, construction equipment (e.g., construction vehicles), may be added onto roads, pedestrians may be added onto sidewalks, and bicycles may be added onto sidewalks and/or roads for the original datasets.

Referring to FIG. 2, the augmented dataset illustrates three objects corresponding to pedestrian added to sidewalks, and three objects corresponding to vehicles added to roads for the original dataset.

The data augmentation is performed on a plurality of original datasets with different scenes, thereby obtaining a desired quantity of learning data.

When the learning data are acquired, machine learning for (e.g., training) deep learning object perception apparatus is performed by using the learning data (S400). The trained deep learning object perception apparatus may be used, for example, to identify object(s) and person(s) around a LiDAR-equipped vehicle with a greater efficiency and accuracy.

As illustrated in FIG. 3, the deep learning model include a common (e.g., shared) backbone network and a plurality of head networks that each outputs a loss for each class.

In the deep learning model, the issue of gradient imbalance due to class imbalance can be partially solved by learning the usage of the enhanced learning data augmented by the contextual ground-truth sampling technique, and the gradient imbalance for each head can also be solved by calculating the total weighted value through the dynamic weight average (DWA) method (e.g., scheme) according to the final loss output,

Since the DWA method can be applied by the introduced method from the thesis “End-to-end multi-task learning with attention” (Liu, Shikun and 2 et al. 2, Proceedings of the IEEE/CVF conference on computer vision and pattern recognition. 2019), the detailed description is omitted for the DWA method itself.

Through the DWA method that is a multi-task learning technique, training each head can be balanced and overall learning results can be improved.

FIG. 4 illustrates a process of applying the DWA method with the assumption of the number of classes being 2.

As shown in FIG. 4, the loss values of steps t−1 and t−2 are used to calculate the α at the current step t in such a way as to use the magnitude of the loss output from each head to update the weight α for each head.

Referring to the equation of FIG. 4, the weight α for each head has a larger weight as the change of loss quantity of the corresponding head increases. The larger weight signifies that the weight by the output of the head in the final loss calculation is increased, and consequently, provides a meaning of a greater influence on learning.

Backpropagation is performed through the final loss to which the weights are applied, and the network weights of the common (e.g., shared) backbone and all heads are updated. In this way, network learning proceeds through backpropagation and correction of weights at each step.

The internal architecture of the network part consisting of the common (e.g., shared) backbone and the multi-head is not specifically presented, but as an example, a previously disclosed network such as PointPillars, PV-RCNN, Voxel-RCNN, or the like, can be used.

Meanwhile, the LiDAR-based deep learning object perception apparatus may include a non-transitory memory storing object perception software and at least one processor executing the software stored in the memory as shown in FIG. 5. The LiDAR-based deep learning object perception apparatus may, for example, be equipped inside a vehicle to identify object(s) and/or person(s) around the vehicle. Alternatively, the LiDAR-based deep learning object perception apparatus may be located outside the vehicle (e.g., in a server) and used to assist the vehicle in identifying the objects around the vehicle. The identified object may be, for example, displayed, via a display in the vehicle, to a user and/or further processed for the purposes of evading and/or keeping a distance from the objects(s) and/or the person(s).

The object perception software is based on a deep learning model learned according to the above described method.

In addition, the LiDAR-based deep learning object perception apparatus includes a LiDAR sensor configured to acquire point clouds from the surrounding environment.

The processor executes object perception software for the point cloud data for the surrounding environment acquired using the LiDAR sensor, and outputs the perceived (e.g., recognition, detected) result.

For example, the processor may be a computer, a microprocessor, a central processing unit (CPU), an application-specific integrated circuit (ASIC), an electronic circuit (e.g., circuitry, logic circuits), or a combination thereof.

In addition, the computer-readable recording medium or the memory includes all types of storage devices in which data can be read by a stored computer system. For example, the memory may include at least a flash memory type, a hard disk drive, a micro type, a card type (i.e., a SD card (Secure Digital Card) or a XD card (eXtream Digital Card), and a memory of a Random Access Memory (RAM), a Static RAM (SRAM), a Read-Only Memory (ROM), a Programmable ROM (PROM), an Electrically Erasable PROM (EEPROM), a Magnetic RAM (MRAM), a magnetic disk, or an optical disk.

The contextual ground-truth sampling technique resolves the imbalance of the number of objects per class in the learning data by changing the learning data itself in correspondence to the input of deep learning. In the dynamic weighted average method, the quantity of updating a network weight for each class is controlled by changing a loss weight for each class when calculating a loss corresponding to an output of the deep learning network.

Since the contextual ground-truth sampling technique changes the learning data itself, the problem of class imbalance can be more directly controlled. However, this technique cannot counteract against variables that occur in the process of converging the network weight during the learning process because the learning data is augmented through the pre-designed rules.

In the case of the dynamic weighted average method, loss weights for each head are updated by mathematical calculation through the loss for each head that is theoretically calculated for every step, and thus a problem of performance deviation that occur during the convergence process of the network can be solved. However, the influence may be lower than that of directly manipulating learning data, and it may be difficult to control to obtain the desired performance.

FIG. 6 quantitatively shows perception results using Comparative Samples.

Comparative Sample 1 is a case where PointPillars is used and learning data is augmented in the prior art, and Improved Sample 1 is a case where PointPillars is used and data augmented according to the present disclosure is applied.

In case of cars, pedestrians, and bicycles as shown in FIG. 6, it can be seen that the perception performance of Improved Sample 1 improves the second-dimensional data in a Bird Eyes View (BEV), as well as the third-dimensional data.

Meanwhile, Comparative Sample 2 is a case in which PV-RCNN is used and learning data from the prior art is augmented, and Improved Sample 2 is a case in which PV-RCNN is used and the data augmentation is applied.

In the case of Improved Sample 2, the perception performance is also improved in all classes compared to Comparative Sample 2.

Comparative Sample 3 is a case in which Voxel RCNN is used and learning data of the prior art is increased, and Improved Sample 3 is a case in which Voxel RCNN is used and data is increased.

In the case of Improved Sample 3, the results of improving the perception performance compared to Comparative Sample 3 are also shown.

Meanwhile, KITTI datasets are used as the datasets used in the Comparative Sample and the Improved Sample of FIG. 6.

In addition, FIG. 7A and FIG. 7B qualitatively compare the perception results of Comparative Sample 4 and Improved Sample 4.

The datasets used in Comparative Sample 4 and Improved Sample 4 are nuScenes datasets, and FIG. 7A shows that Comparative Sample 4 conforming to the prior art includes misperceived (e.g., incorrectly recognized) data in contrast to Improved Sample 4 in FIG. 7B.

What is claimed is:

1. A method comprising:
obtaining, by a processor, at least one virtual object dataset from a point cloud database;
obtaining learning datasets by adding, based on object-associated position information for at least one object, the at least one virtual object dataset to a first dataset of the at least one object;
training a LiDAR-based deep learning object perception apparatus based on the learning datasets; and
identifying, via the trained LiDAR-based deep learning object perception apparatus, the at least one object.

2. The method of claim 1, wherein the at least one virtual object dataset comprises at least one dynamic object dataset obtained from at least one point cloud dataset of the point cloud database.

3. The method according to claim 2, wherein the at least one dynamic object dataset comprises at least one of: a pedestrian, a bicycle, a motorcycle, a passenger vehicle, a truck, a bus, a trailer, or construction equipment.

4. The method according to claim 1, wherein the object-associated position information for the at least one object is determined according to point label information of the first dataset.

5. The method according to claim 4, wherein the point label information comprises at least one of: a sidewalk, a drivable area, or a road.

6. The method according to claim 5, wherein the object-associated position information comprises at least one of:
an association between:
at least one of: a motorcycle, a passenger vehicle, a truck, a bus, a trailer, or construction equipment, and
the road,
an association between a pedestrian and the sidewalk, or
an association between a bicycle and one of the sidewalk or the road.

7. The method of claim 1, wherein the LiDAR-based deep learning object perception apparatus comprises:
non-transitory memory storing object perception software based on a deep learning model; and
at least one processor executing the object perception software in the non-transitory memory, and
wherein the deep learning model comprises a shared backbone network and a plurality of head networks that each outputs a loss for each class.

8. The method of claim 7, further comprising outputting, via the deep learning model, a final loss, wherein the final loss comprises a weighted sum of losses output from the plurality of head networks.

9. The method of claim 8, further comprising determining the final loss based on a dynamic weight average (DWA) scheme.

10. The method of claim 1, wherein the point cloud database comprises at least one of: a nuScenes dataset or a Karlsruhe Institute of Technology and Toyota Technological Institute (KITTI) dataset.

11. A LIDAR-based deep learning object perception apparatus comprising:
non-transitory memory storing object perception software based on a deep learning model; and
at least one processor configured to execute the object perception software stored in the non-transitory memory,
wherein the deep learning model is trained based on learning datasets,
wherein the learning datasets are obtained by adding, based on object-associated position information for at least one object, at least one virtual object dataset to original datasets,
wherein the virtual object dataset is obtained from a point cloud database, and
wherein the at least one processor is configured to execute the object perception software to cause the LiDAR-based deep learning object perception apparatus to identify, based on the deep learning model, the at least one object.

12. The LiDAR-based deep learning object perception apparatus of claim 11, wherein the virtual object dataset comprises at least one dynamic object dataset obtained from at least one point cloud dataset of the point cloud database.

13. The LiDAR-based deep learning object perception apparatus of claim 12, wherein the at least one dynamic object dataset comprises at least one of: a pedestrian, a bicycle, a motorcycle, a passenger vehicle, a truck, a bus, a trailer, or construction equipment.

14. The LiDAR-based deep learning object perception apparatus of claim 11, wherein the object-associated position information for the at least one object is determined according to point label information of the original datasets.

15. The LiDAR-based deep learning object perception apparatus of claim 14, wherein the point label information comprises at least one of: a sidewalk, a drivable area, or a road.

16. The LiDAR-based deep learning object perception apparatus of claim 15, wherein the object-associated position information comprises at least one of:
an association between:
a motorcycle, a passenger vehicle, a truck, a bus, a trailer, or construction equipment, and
the road,
an association between a pedestrian and the sidewalk, or
an association between a bicycle with and one of sidewalk or the road.

17. The LiDAR-based deep learning object perception apparatus of claim 11, wherein the deep learning model comprises a shared backbone network and a plurality of head networks that each outputs a loss for each class.

18. The LiDAR-based deep learning object perception apparatus of claim 17, wherein the deep learning model outputs a final loss, and wherein the final loss comprises a weighted sum of losses output from the plurality of head networks.

19. The LiDAR-based deep learning object perception apparatus of claim 18, wherein the final loss is based on a dynamic weight average (DWA) scheme.

20. The LiDAR-based deep learning object perception apparatus of claim 11, wherein the point cloud database comprises at least one of: a nuScenes dataset or a Karlsruhe Institute of Technology and Toyota Technological Institute (KITTI) datasets.
